(19) United States
(12) Patent Application Publication
(10) Pub. No.: US 2020/0324753 A1
(43) Pub. Date: Oct. 15, 2020

(54) CONTROL SYSTEM FOR VEHICLE

(71) Applicant: TOYOTA JIDOSHA KABUSHIKI KAISHA, Toyota-shi (JP)

(72) Inventors: Shuntaro SHINOHARA, Susono-shi (JP); Hiroyasu KITAGAWA, Susono-shi (JP); Hideaki OTSUBO, Aichi-gun (JP); Koichiro MUTA, Okazaki-shi (JP); Yoshinori FUJITAKE, Toyota-shi (JP); Takuya HIRATA, Susono-shi (JP); Hiromitsu METSUGI, Toyota-shi (JP)

(73) Assignee: TOYOTA JIDOSHA KABUSHIKI KAISHA, Toyota-shi (JP)

(21) Appl. No.: 16/821,350

(22) Filed: Mar. 17, 2020

(30) Foreign Application Priority Data
Apr. 9, 2019 (JP) 2019-074383

(51) Int. Cl. B60W 10/08; F02D 41/10

(52) U.S. Cl. CPC B60W 10/08; F02D 41/10; B60W 2710/0677; B60W 2710/086; B60W 2540/103

(57) ABSTRACT

A control system for vehicles that controls drive force and acceleration smoothly without causing a shock, in response to an operation of an accelerator pedal. A hysteresis is set between an input value and an output value of angle of the accelerator pedal. The hysteresis includes a deadband and an asymptotic range. The output value is not changed significantly with respect to a change in the input value if an angle of the accelerator pedal is changed within the deadband, and the output value is changed continuously with respect to a change in the input value based on a predetermined function if an angle of the accelerator pedal is changed within the asymptotic range.

### CROSS REFERENCE TO RELATED APPLICATIONS

The present disclosure claims the benefit of Japanese Patent Application No. 2019-074383 filed on Apr. 9, 2019 with the Japanese Patent Office, the disclosure of which are incorporated herein by reference in its entirety.

### BACKGROUND

### Field of the Disclosure

Embodiments of the present disclosure relate to the art of a control system for a vehicle configured to control drive force or acceleration of the vehicle in accordance with an operation of an accelerator pedal.

### Discussion of the Related Art

JP-B2-H07-68924 describes a throttle valve control device that controls an opening degree of a throttle valve arranged in an engine of an automobile in accordance with a position of an accelerator pedal. According to the teachings of JP-B2-H07-68924, a hysteresis is set between the opening degree of the throttle valve and the position of the accelerator pedal. Specifically, a hysteresis width of a case in which an operating amount of the accelerator pedal is large is narrower than the hysteresis width of a case in which the operating amount of the accelerator pedal is small.

JP-A-2006-283561 describes a pedal system in which a hysteresis is set in the relationship between a pedal force applied to an accelerator pedal and a vehicle output (i.e., a driving force). According to the teachings of JP-A-2006-283561, the hysteresis is set in such a manner as to be indicated as a straight line or a folded line.

JP-A-2006-281810 describes a pedal device in which a hysteresis and a deadband between a pedal force applied to an accelerator pedal and a vehicle output. According to the teachings of JP-A-2006-281810, a relation between the pedal force and the vehicle output is altered when depressing the accelerator pedal and when returning the accelerator pedal. Specifically, the relation between the pedal force and the vehicle output is set in such a manner that the vehicle output is increased at a constant rate with respect to an increase in the pedal force when retaining a position of the accelerator pedal.

As described, according to the teachings of JP-A-2011-250648 and JP-A-2006-281810, the drive force to propel the vehicle is controlled based on the pedal force applied to the accelerator pedal. In general, the accelerator pedal is returned elastically by a spring. According to the teachings of those prior art documents, therefore, the hysteresis is set taking account of such structure of the accelerator pedal. Specifically, a width of the hysteresis is widened in accordance with an increase in the pedal force. That is, the pedal force to depress the accelerator pedal is increased in proportion to an increase in a depression of the accelerator pedal. For this reason, according to the teachings of those prior art documents, the hysteresis width is widened in accordance with an increase in an operating amount of the accelerator pedal.

JP-B2-5157834 describes a drive force control system for a vehicle. According to the teachings of JP-B2-5157834, a hysteresis is also set between a position of an accelerator pedal and a drive force to propel the vehicle. Specifically, the hysteresis is varied when depressing the accelerator pedal and when returning the accelerator pedal. In addition, when an operating speed of the accelerator pedal is fast, a variation width of the drive force is increased compared to a variation width of an operating amount of the accelerator pedal. That is, the hysteresis is set in such a manner that the drive force is changed slowly with respect to a change in the position of the accelerator pedal. In other words, the operating amount of the accelerator pedal is rounded in a temporal axis. Therefore, a driver inevitably feels a temporal stagnation with respect to an operation of the accelerator pedal.

According to the teachings of JP-B2-H07-68924, the hysteresis is set between the opening degree of the throttle valve and the position of the accelerator pedal so as to prevent a hunting during controlling output power of the engine or drive force to propel the vehicle in accordance with an operation of the accelerator pedal. For example, as indicated in FIG. 1, the hysteresis is set between an input value of the position of the accelerator pedal and an output value of the position of the accelerator pedal. According to the example shown in FIG. 1, the output value of the position of the accelerator pedal is not changed when the accelerator pedal is depressed from a point a to point b, and when the accelerator pedal is returned from c point a to point d. That is, in the example shown in FIG. 1, an entire width of such hysteresis in a direction of change in the input value of the accelerator pedal corresponds to a deadband for preventing an occurrence of hunting or chattering.

However, if the drive force is controlled based on a relation between the input value and the output value of the position of the accelerator pedal, a shock may be caused undesirably. For example, when the accelerator pedal is depressed from a position I1 to a position I2 in the example shown in FIG. 1, the output value of the position of the accelerator pedal starts changing abruptly from the point b. Consequently, the drive force to propel the vehicle is increased abruptly thereby causing a shock. Further, when the accelerator pedal is manipulated slightly around a position I3, the output value of the position of the accelerator pedal is fluctuated significantly. Consequently, the drive force to propel the vehicle is fluctuated to disturb the behavior of the vehicle.

In order to reduce the above-explained shock and to stabilize the vehicle behavior, the conventional control of the drive force or acceleration in response to a depression of the accelerator pedal has to be improved.

### SUMMARY

Aspects of embodiments of the present disclosure have been conceived noting the foregoing technical problems, and it is therefore an object of the present disclosure to provide a control system for vehicles that controls drive force and acceleration smoothly without causing a shock, in response to an operation of an accelerator pedal.

The control system according to the exemplary embodiment of the present disclosure is applied to a vehicle having a prime mover, an accelerator pedal, and a detector that detects an operating amount of the accelerator pedal. The control system comprises a controller that calculates an output value of the operating amount of the accelerator pedal with respect to an input value of the operating amount of the accelerator pedal transmitted from the detector, with reference to a predetermined input-output characteristic including a hysteresis set between the input value and the output value. The controller controls the prime mover based on the calculated output value. Specifically, the hysteresis includes: a deadband in which the output value is not changed with respect to a change in the input value, or changed slightly with respect to a change in the input value but not sensed by a driver; and an asymptotic range in which the output value is changed continuously with respect to a change in the input value based on a predetermined function indicated as a curve or a polygonal curve, when the input value is changed further than the deadband. In order to achieve the above-explained objective, according to the exemplary embodiment of the present disclosure, the controller is configured to: store the input-output characteristic, the deadband, and the asymptotic range; increase the output value slightly with respect to an increase in the input value, or not to increase the output value with respect to an increase in the input value, when the input value is increased within the deadband; reduce the output value slightly with respect to a reduction in the input value, or not to reduce the output value with respect to a reduction in the input value, when the input value is reduced within the deadband; increase the output value with respect to an increase in the input value based on the function when the input value is increased further than the deadband; and reduce the output value with respect to a reduction in the input value based on the function when the input value is reduced further than the deadband.

In a non-limiting embodiment, the deadband may include at least any one of: a first deadband in which the output value is not increased or increased slightly with respect to an increase in the input value; and a second deadband in which the output value is not reduced or reduced slightly with respect to a reduction in the input value. On the other hand, the asymptotic range may include at least any one of: a first asymptotic range in which the output value is increased with respect to an increase in the input value based on the function when the input value is increased further than the first deadband; and a second asymptotic range in which the output value is reduced with respect to a reduction in the input value based on the function when the input value is reduced further than the second deadband.

In a non-limiting embodiment, the first asymptotic range may be set in such a manner that an increasing rate of the output value with respect to an increase in the input value is increased with an increase in the operating amount of the accelerator pedal within the first asymptotic range.

In a non-limiting embodiment, the second asymptotic range may be set in such a manner that a decreasing rate of the output value with respect to a reduction in the input value is increased with a reduction in the operating amount of the accelerator pedal within the second asymptotic range.

Thus, the control system according to the exemplary embodiment of the present disclosure is configured to control the prime mover in response to an operation of the accelerator pedal. To this end, an operating amount of the accelerator pedal is detected, and transmitted to the controller. The controller calculates the output value of the operating amount of the accelerator pedal with respect to the input value based on the predetermined input-output characteristic, and transmits the calculated output value to the prime mover to control drive force to propel the vehicle based on the calculated output value. As described, according to the exemplary embodiment of the present disclosure, the hysteresis is set between the input value and the output value. According to the exemplary embodiment of the present disclosure, therefore, the prime mover can be controlled without causing a hunting and a chattering. Specifically, the hysteresis is set by combining the deadband with the asymptotic range. Since the hysteresis includes the deadband, an occurrence of the hunting or the chattering can be prevented. In the asymptotic range, the output value of the operating amount of the accelerator pedal is changed smoothly and continuously with respect to a change in the input value. According to the exemplary embodiment of the present disclosure, therefore, the output power of the prime mover can be changed continuously and smoothly without causing a shock in response to a change in a position of the accelerator pedal. In addition, even if a position of the accelerator pedal is fixed while the accelerator pedal is being depressed or returned, the drive force to propel the vehicle can be maintained stably.

According to the exemplary embodiment of the present disclosure, the deadband and the asymptotic range are set in each depressing direction and returning direction of the accelerator pedal. According to the exemplary embodiment of the present disclosure, therefore, the drive force to propel the vehicle can be controlled smoothly not only when depressing the accelerator pedal but also when returning the accelerator pedal.

According to the exemplary embodiment of the present disclosure, in the first asymptotic range, the increasing rate of the output value with respect to an increase in the input value is increased with an increase in the operating amount of the accelerator pedal within the first asymptotic range. Specifically, in a coordinate system in which the horizontal axis represents the input value and the vertical axis represents the output value, the curve governed by the function within the first asymptotic range is bulged downwardly. That is, the output value is not increased sharply with respect to an increase in the input value in an initial phase of depression of the accelerator pedal, but an increased amount of the output value per unit operation of the accelerator pedal is increased gradually with an increase in depression of the accelerator pedal. According to the exemplary embodiment of the present disclosure, therefore, the drive force to propel the vehicle can be increased smoothly and continuously with respect to an increase in depression of the accelerator pedal. In addition, even if a position of the accelerator pedal is fixed while the accelerator pedal is depressed, the drive force to propel the vehicle can be maintained stably.

According to the exemplary embodiment of the present disclosure, in the second asymptotic range, the decreasing rate of the output value with respect to a reduction in the input value is increased with a reduction in the operating amount of the accelerator pedal within the second asymptotic range. Specifically, in the coordinate system in which the horizontal axis represents the input value and the vertical axis represents the output value, the curve governed by the function within the first asymptotic range is bulged upwardly. That is, the output value is not reduced sharply with respect to a reduction in the input value in an initial phase of depression of the accelerator pedal, but a decreased amount of the output value per unit operation of the accelerator pedal is increased gradually with a reduction in depression of the accelerator pedal. According to the exemplary embodiment of the present disclosure, therefore, the drive force to propel the vehicle can be increased smoothly and continuously with respect to a reduction in depression of the accelerator pedal. In addition, even if a position of the accelerator pedal is fixed while the accelerator pedal is returned, the drive force to propel the vehicle can be maintained stably.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a conventional map for determining an output value of a position of an accelerator pedal with respect to an input value of a position of the accelerator pedal in which a hysteresis is set therebetween;

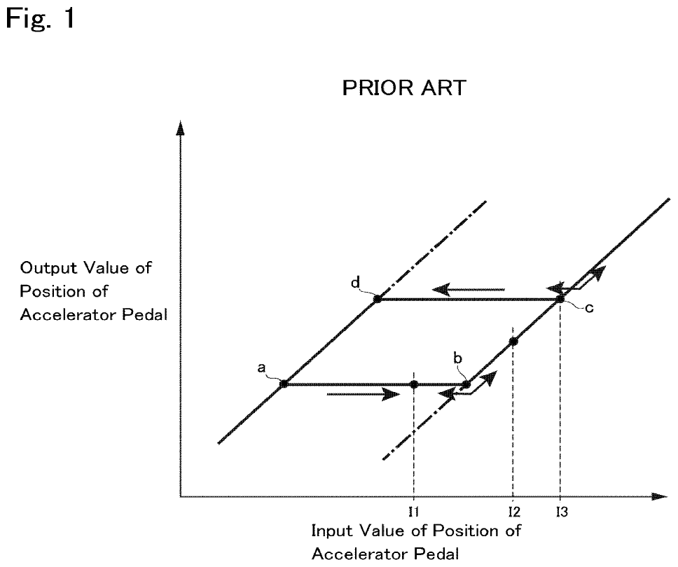

FIG. 2 is a schematic illustration showing one example of a structure of a vehicle to which the control system according to the exemplary embodiment of the present disclosure is applied;

FIG. 3 is a block diagram schematically showing the control system according to the exemplary embodiment of the present disclosure;

FIG. 4 is a flowchart showing an example of a routine executed by the control system according to the exemplary embodiment;

FIG. 5 is a first example of a map determining the hysteresis in which the deadband and the asymptotic range in a depressing direction and the deadband and the asymptotic range in a returning direction are set symmetrically;

FIG. 6 is a second example of the map determining the hysteresis in which the deadband and the asymptotic range in the depressing direction and the deadband and the asymptotic range in the returning direction are set asymmetrically;

FIG. 7 is a third example of the map determining the hysteresis in which only the deadband is set in the returning direction; and

FIG. 8 is a fourth example of the map determining the hysteresis in which only the asymptotic range is set in the returning direction.

### DETAILED DESCRIPTION OF THE PREFERRED EMBODIMENT(S)

An exemplary embodiment of the present disclosure will now be explained with reference to the accompanying drawings.

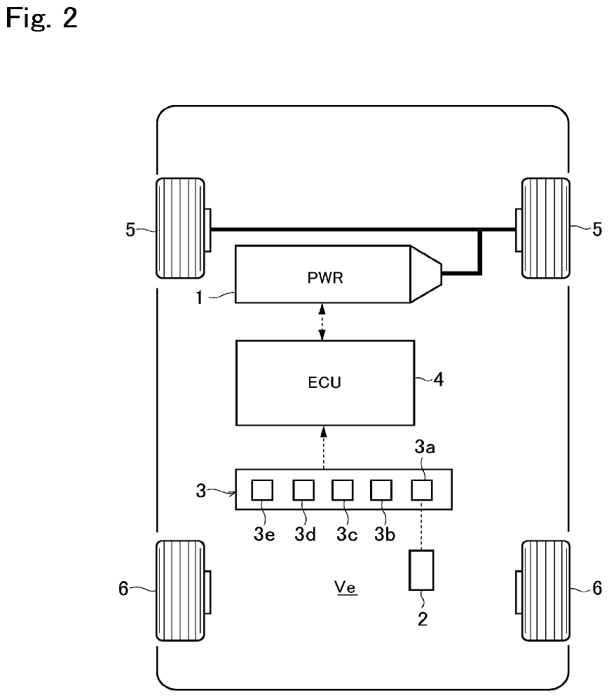

Referring now to FIG. 2, there is shown one example of a drive system of a vehicle Ve to which the control system according to the embodiment of the present disclosure is applied. The vehicle Ve illustrated in FIG. 2 comprises a prime mover (referred to as “PWR” in FIG. 2) 1, an accelerator pedal 2, a detector 3, and a controller (referred to as “ECU” in FIG. 2) 4.

The prime mover 1 generates a drive torque to establish a drive force to propel the vehicle Ve. For example, an internal combustion engine such as a gasoline engine and a diesel engine may be adopted as the prime mover 1. An output power of the engine may be adjusted electrically, and the engine may be started and stopped electrically according to need. Given that the gasoline engine is adopted as the prime mover 1, an opening degree of a throttle valve, an amount of fuel supply or fuel injection, a commencement and a termination of ignition, an ignition timing etc. may be controlled electrically. Otherwise, given that the diesel engine is adopted as the prime mover 1, an amount of fuel injection, an injection timing, an opening degree of a throttle valve of an EGR (Exhaust Gas Recirculation) system etc. may be controlled electrically.

Instead, a permanent magnet type synchronous motor, and an induction motor may be adopted as the prime mover 1. Those kinds of motors may serve not only as a motor to generate torque when driven by electricity supplied thereto, but also as a generator to generate electricity when rotated by a torque applied thereto. That is, a motor-generator may also be adopted as the prime mover 1. In this case, the prime mover 1 is switched between a motor and a generator by electrically controlling the prime mover 1, and an output speed and an output torque of the prime mover 1 may be controlled electrically.

In the vehicle Ve shown in FIG. 2, a pair of front wheels 5 serve as drive wheels, and a drive torque generated by the prime mover 1 is delivered to the front wheels 5 to propel the vehicle Ve. However, the vehicle control system according to the embodiment of the present disclosure may also be applied to a rear-drive layout vehicle in which a pair of rear wheels 6 serve as drive wheels, and a four-wheel drive vehicle in which all of the wheels are driven by the torque of the prime mover 1. In a case of using the engine as the prime mover 1, a transmission (not shown) may be arranged downstream of the prime mover 1 to deliver the output torque of the prime mover 1 to the drive wheels via the transmission.

The prime mover 1 generates a torque by depressing the accelerator pedal 2 thereby establishing the drive force to propel and accelerate the vehicle Ve. To this end, a target acceleration is set based on e.g., a position of the accelerator pedal 2 and a speed of the vehicle Ve, and an output power of the prime mover 1 is controlled in such a manner as to achieve the target acceleration. The torque of the prime mover 1 is increased with an increase in depression of the accelerator pedal 2 to increase the drive force to propel the vehicle Ve. In other words, the torque of the prime mover 1 is varied in accordance with a position of the accelerator pedal 2. By contrast, the torque of the prime mover 1 is reduced by returning the accelerator pedal 2 to reduce the drive force to propel the vehicle Ve. In other words, the torque of the prime mover 1 is reduced in response to a reduction in depression of the accelerator pedal 2.

The drive force and the acceleration of the vehicle Ve is controlled by manipulating the accelerator pedal 2. For this purpose, the detector 3 includes an accelerator sensor 3a that collects information about the accelerator pedal 2 including an operating amount of the accelerator pedal 2, an angle of the accelerator pedal 2, a position (i.e., a depression) of the accelerator pedal 2 and so on. Based on the information collected by the accelerator sensor 3a, an operating speed of the accelerator pedal 2 may be computed. By obtaining the operating speed of the accelerator pedal 2, for example, an operating direction of the accelerator pedal 2 can be estimated. That is, it is possible to determine whether the accelerator pedal 2 is depressed or returned by a driver.

In order to collect information about a condition of the vehicle Ve, the detector 3 further includes: a wheel speed sensor 3b that detects a speed of the vehicle Ve; an acceleration sensor 3c that detects a longitudinal acceleration of the vehicle Ve; a speed sensor 3d that detects a rotational speed of an output shaft (not shown) of the prime mover 1; and a brake stroke sensor 3e that detects an operating amount (i.e., stroke) of a brake pedal (not shown). The detector 3 is electrically connected to an after-mentioned controller 4 so that detection values obtained by those sensors are transmitted to the controller 4 in the form of an electric signal.

Specifically, the controller 4 is an electronic control unit including a microcomputer. In order to control the vehicle Ve, the data collected by the detector 3 is sent to the controller 4, and the controller 4 performs calculation using the incident data from the detector 3, as well as data and formulas stored in advance. Calculation results are transmitted from the controller 4 in the form of command signal.

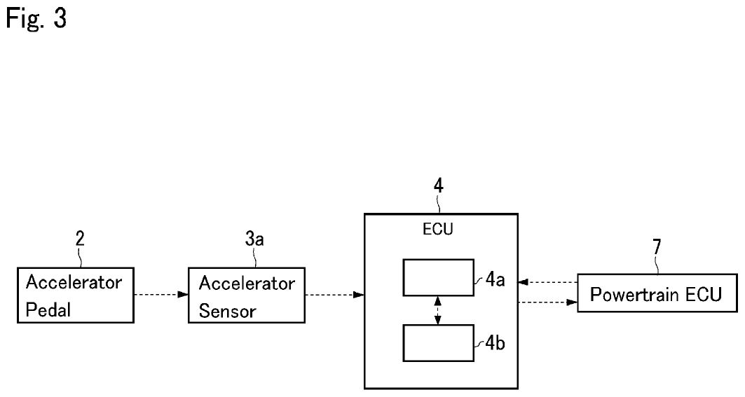

As illustrated in FIG. 3, the controller 4 comprises a calculator section 4a, and a controller section 4b. For example, the calculator section 4a receives the data relating to the condition of the accelerator pedal 2 from the accelerator sensor 3a, and calculates a target acceleration to accelerate the vehicle Ve or a target drive torque to propel the vehicle Ve based on the data transmitted from the accelerator sensor 3a. On the other hand, the controller section 4b controls a longitudinal acceleration of the vehicle Ve based on the target acceleration or the target drive torque calculated by the calculator section 4a. To this end, the controller section 4b transmits a control command signal e.g., to the prime mover 1 so as to achieve the target acceleration.

Thus, the controller 4 is configured to set a target acceleration based on a position of the accelerator pedal 2, and to control an output power of the prime mover 1 thereby adjusting a drive force and a brake force to achieve the target acceleration. Although only one controller 4 is depicted in FIG. 3, a plurality of controllers may be arranged in the vehicle Ve to control the specific devices individually. For example, as shown in FIG. 3, the controller 4 may be used as a main controller to control the vehicle Ve integrally in conjunction with a powertrain ECU 7 dedicated to control the prime mover 1 and a transmission.

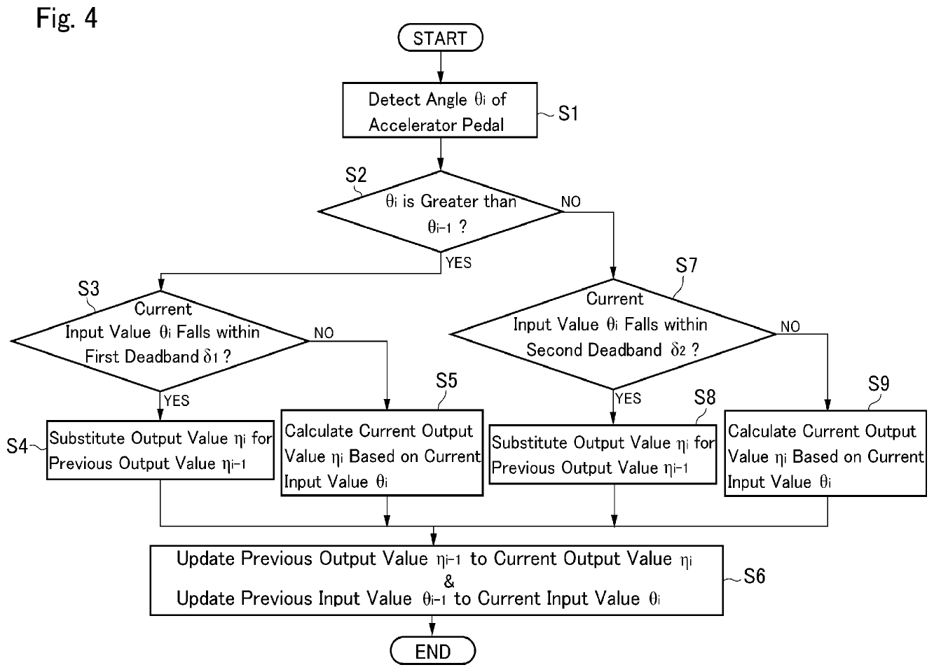

The control system according to the exemplary embodiment of the present disclosure is configured to control the drive force to propel and accelerate the vehicle Ve in response to an operation of the accelerator pedal 2 smoothly without causing a shock, and to stabilize the behavior of the vehicle Ve while a position of the accelerator pedal 2 is maintained. To this end, the controller 4 executes the routine shown in FIG. 4.

The routine shown in FIG. 4 is commenced when the accelerator pedal 2 is operated by the driver. At step S1, a current angle θ of the accelerator pedal 2 is detected by the accelerator sensor 3a, and sent to the controller 4. Hereinafter, the angle θ of the accelerator pedal 2 sent to the controller 4 will also be called the input value θi of the angle of the accelerator pedal 2.

Then, it is determined at step S2 whether the input value θi of the angle of the accelerator pedal 2 is greater than an input value θi−1 of the angle of the accelerator pedal 2 sent to the controller 4 in the previous routine. Given that the routine shown in FIG. 4 is configured to detect an angle of the accelerator pedal at predetermined time intervals, a previous detection value of the angle of the accelerator pedal 2 may also be employed as the input value θi-1. That is, at step S2, it is determined whether the accelerator pedal 2 is currently being depressed or returned. In other words, it is determined whether the angle of the accelerator pedal 2 is being increased or reduced.

If the current input value θi of the angle of the accelerator pedal 2 is greater than the input value θi-1 detected in the previous routine so that the answer of step S2 is YES, the routine progresses to step S3. In other words, if the accelerator pedal 2 is being depressed, the routine progresses from step S2 to step S3.

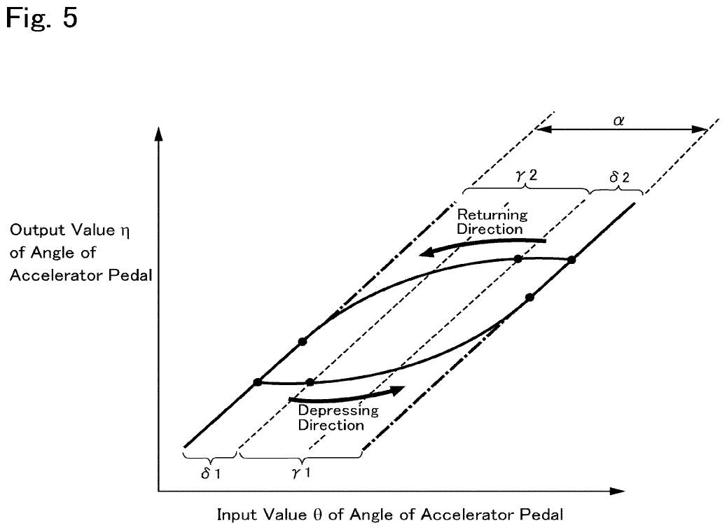

At step S3, it is determined whether the current input value θi of the angle of the accelerator pedal 2 falls within a first deadband δ1 set in a depressing direction. According to the exemplary embodiment of the present disclosure, a relation between the input value θi of the angle of the accelerator pedal 2 inputted to the controller 4 and an output value η of the angle of the accelerator pedal 2 outputted from the controller 4 is governed by a specific input-output characteristic stored in the controller 4. The input value θi includes data relating to an operating amount of the accelerator pedal 2 which is detected by the accelerator sensor 3a to be transmitted to the controller 4. On the other hand, the output value η of the angle of the accelerator pedal 2 is computed with respect to the input value θi to the controller 4 based on the input-output characteristic, and transmitted from the controller 4 in the form of command signal to the prime mover 1. Turning to FIG. 5 as a coordinate system, there is shown a first example of a hysteresis which is set between the input value θi and the output value η of the angle of the accelerator pedal 2, based on the input-output characteristic. In FIG. 5, the horizontal axis represents the input value θ of the angle of the accelerator pedal 2, the vertical axis represents the output value η of the angle of the accelerator pedal 2, and a represents a width of the hysteresis in a direction of changing an angle of the accelerator pedal 2. As shown in FIG. 5, the hysteresis includes a deadband δ and an asymptotic range γ.

Given that the input value θi of the angle of the accelerator pedal 2 is changed within the deadband δ, the output value η of the angle of the accelerator pedal 2 will not be changed, or changed slightly but a change in the drive force resulting from such slight change in the output value η will not be sensed by the driver. As can be seen from FIG. 5, the deadband δ includes the first deadband δ1 set in the depressing direction and a second the deadband δ2 set in a returning direction. For example, given that the accelerator pedal 2 is depressed within the first deadband δ1 so that the input value θi of the angle of the accelerator pedal 2 is increased, the output value η of the angle of the accelerator pedal 2 will not be increased, or increased slightly. By contrast, given that the accelerator pedal 2 is returned within the second deadband δ2 so that the input value θi of the angle of the accelerator pedal 2 is reduced, the output value η of the angle of the accelerator pedal 2 will not be reduced, or reduced slightly.

In the asymptotic range γ, the output value η of the angle of the accelerator pedal 2 will be changed continuously based on a predetermined function with respect to a change in the input value θi of the angle of the accelerator pedal 2. In the example shown in FIG. 5, the output value η of the angle of the accelerator pedal 2 is changed continuously with respect to a change in the input value θi of the angle of the accelerator pedal 2, based on a quadric function, an exponential function, a logarithmic function, or a trigonometric function. The asymptotic range γ also includes a first asymptotic range γ1 set in the depressing direction and a second asymptotic range γ2 set in the returning direction. For example, given that the accelerator pedal 2 is depressed so that the input value θi of the angle of the accelerator pedal 2 is increased further than the first deadband δ1 to enter the first asymptotic range γ1, the output value η of the angle of the accelerator pedal 2 will be increased e.g., exponentially within the first asymptotic range γ1. By contrast, given that the accelerator pedal 2 is returned so that the input value θi of the angle of the accelerator pedal 2 is reduced further than the second deadband δ2 to enter the second asymptotic range γ2, the output value η of the angle of the accelerator pedal 2 will be reduced e.g., exponentially within the second asymptotic range γ2.

That is, given that the accelerator pedal 2 is depressed so that the input value θi of the angle of the accelerator pedal 2 is increased further than the first deadband δ1 to enter the first asymptotic range γ1, the output value η of the angle of the accelerator pedal 2 will be increased smoothly and continuously from the first deadband δ1 to the first asymptotic range γ1. By contrast, given that the accelerator pedal 2 is returned so that the input value θi of the angle of the accelerator pedal 2 is reduced further than the second deadband δ2 to enter the second asymptotic range γ2, the output value η of the angle of the accelerator pedal 2 will be reduced smoothly and continuously from the second deadband δ2 to the second asymptotic range γ2.

Turning back to FIG. 4, if the current input value θi of the angle of the accelerator pedal 2 falls within the first deadband δ1 so that the answer of step S3 is YES, the routine progresses to step S4 to substitute a current output value of the angle of the accelerator pedal 2 for a previous output value ηi−1 of the angle of the accelerator pedal 2 outputted from the controller 4 in the previous routine.

In this situation, however, a position of the accelerator pedal 2 being depressed is changed merely slightly within the first deadband δ1. Therefore, the previous output value ηi−1 with respect to the current input value θi is maintained. That is, the output value η of the angle of the accelerator pedal 2 from the controller 4 is not changed even if the input value of the angle of the accelerator pedal 2 has been changed slightly from the previous input value θi−1 to the current input value θi.

By contrast, if the current input value θi of the angle of the accelerator pedal 2 is increased further than the first deadband δ1 so that the answer of step S3 is NO, the routine progresses to step S5 to calculate the current output value ηi based on the current input value θi.

In this case, the current output value ηi can be calculated based on a function F1(x) indicated as a curve or a polygonal curve drawn within the first asymptotic range γ1 set in the depressing direction, and as described, the function F1(x) may be a quadric function, an exponential function, a logarithmic function, or a trigonometric function. Specifically, the current output value can be calculated by assigning the current input value θi to a variable (x) of the function F1(x). For example, the function F1(x) may be set in such a manner that the output value η is changed smoothly at a desired rate in accordance with a change in the input value θi, based on a result of simulation or experimentation. According to the exemplary embodiment of the present disclosure, a fractional function is employed as the function F1(x) to calculate the current output value ηi within the first asymptotic range γ1.

Thus, according to the exemplary embodiment of the present disclosure, the hysteresis which is set between the input value θi and the output value η of the angle of the accelerator pedal 2. As described, the hysteresis has a width a, and the hysteresis includes the first deadband δ1 and the first asymptotic range γ1 in the depressing direction. Specifically, as indicated in FIG. 5, the curve governed by the function F1(x) drawn within the first asymptotic range γ1 is bulged downwardly. That is, in the case of depressing the accelerator pedal 2, an increasing rate of the output value η with respect to the input value θi of the accelerator pedal 2 within the first asymptotic range γ1 is increased with an increase in depression of the accelerator pedal 2. In other words, an inclination of the curve governed by the function F 1(x) within the first asymptotic range γ1 becomes steeper with an increase in depression of the accelerator pedal 2. Accordingly, the output value η is not increased sharply with respect to an increase in the input value θi in an initial phase of depression of the accelerator pedal 2, but an increased amount of the output value η per unit operation of the accelerator pedal 2 is increased gradually with an increase in depression of the accelerator pedal 2. According to the exemplary embodiment of the present disclosure, therefore, the drive force to propel the vehicle Ve can be increased smoothly and continuously with respect to an increase in depression of the accelerator pedal 2. In addition, even if a position of the accelerator pedal 2 is fixed while the accelerator pedal 2 is depressed, the drive force to propel the vehicle Ve can be maintained stably.

After calculating the current output value ηi of the angle of the accelerator pedal 2 at step S4 or S5, the routine progresses to step S6 to update the previous output value ηi−1 to the current output value ηi.

In addition, at step S6, the previous input value θi-1 is also updated to the current input value θi, and thereafter the routine returns.

By contrast, if the current input value θi of the angle of the accelerator pedal 2 is smaller than the input value θi-1 detected in the previous routine so that the answer of step S2 is NO, the routine progresses to step S7. In other words, if the accelerator pedal 2 is being returned, the routine progresses from step S2 to step S7.

At step S7, it is determined whether the current input value θi of the angle of the accelerator pedal 2 falls within the second deadband δ2 in the returning direction.

If the current input value θi of the angle of the accelerator pedal 2 falls within the second deadband δ2 so that the answer of step S7 is YES, the routine progresses to step S8 to substitute the current output value ηi of the angle of the accelerator pedal 2 for the previous output value ηi−1 of the angle of the accelerator pedal 2 outputted from the controller 4 in the previous routine.

In this situation, however, a position of the accelerator pedal 2 being returned is changed merely slightly within the second deadband δ2. Therefore, the previous output value ηi−1 with respect to the current input value θi is maintained. That is, the output value η of the angle of the accelerator pedal 2 from the controller 4 is not changed even if the input value of the angle of the accelerator pedal 2 has been changed slightly from the previous input value θi−1 to the current input value θi.

By contrast, if the current input value θi of the angle of the accelerator pedal 2 is reduced further than the second deadband δ2 so that the answer of step S7 is NO, the routine progresses to step S9 to calculate the current output value ηi based on the current input value θi.

In this case, the current output value ηi can be calculated based on a function F2(x) indicated as a curve or a polygonal curve drawn within the second asymptotic range γ2 in the returning direction, and the function F2(x) may also be a quadric function, an exponential function, a logarithmic function, or a trigonometric function. Specifically, the current output value ηi can be calculated by assigning the current input value θi to a variable (x) of the function F2(x). The function F2(x) may also be set in such a manner that the output value η is changed smoothly at a desired rate in accordance with a change in the input value θi, based on a result of simulation or experimentation. According to the exemplary embodiment of the present disclosure, the fractional function is also employed as the function F2(x) to calculate the current output value ηi within the second asymptotic range γ2.

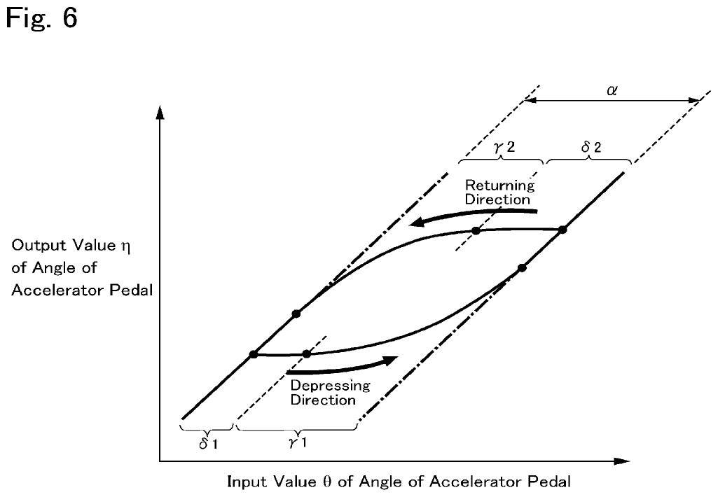

In the example shown in FIG. 5, the function F 1(x) and the function F2(x) are set in such a manner that the curves indicating the function F 1(x) and the function F2(x) are drawn symmetrically with each other. In this case, an acceleration feeling with respect to a depressing operation of the accelerator pedal 2 and a deceleration feeling with respect to the returning operation of the accelerator pedal 2 can be equalized. In this case, therefore, the driver is allowed to accelerate and decelerate the vehicle Ve easily. Turning to FIG. 6, there is shown the second example of the input-output characteristic. As shown in FIG. 6, the input-output characteristic may be differentiated in the depressing direction and in the returning direction, depending on the specifications of the vehicle Ve, and in accordance with the driver's preference.

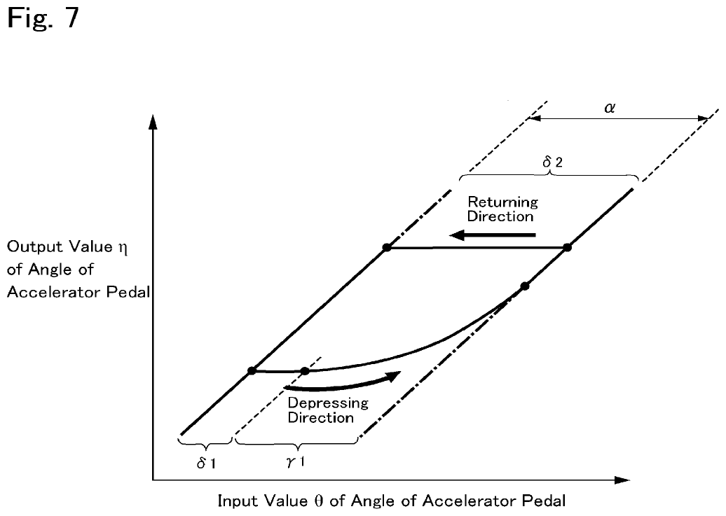

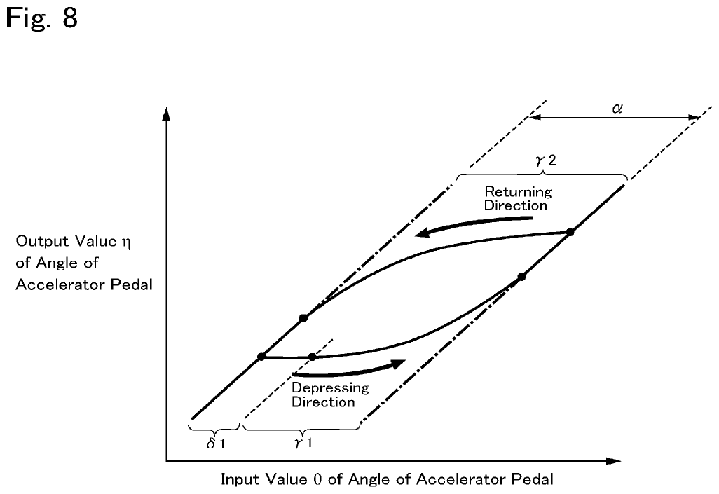

In addition, according to the exemplary embodiment of the present disclosure, the deadband δ may include at least any one of the first deadband δ1 and the second the deadband δ2, and the asymptotic range γ may include at least any one of the first asymptotic range γ1 and the second asymptotic range γ2. For example, according to the third example shown in FIG. 7, the hysteresis includes the first deadband δ1 and the first asymptotic range γ1 in the depressing direction, but only the second deadband δ2 is set in the returning direction. Further, according to the fourth example shown in FIG. 8, the hysteresis includes the first deadband δ1 and the first asymptotic range γ 1 in the depressing direction, but only the second asymptotic range γ2 is set in the returning direction. Although not especially shown, the hysteresis may include the second deadband δ2 and the second asymptotic range γ2 in the returning direction, but only the first deadband δ1 may be set in the depressing direction. By contrast, although not especially shown, the hysteresis may include the second deadband δ2 and the second asymptotic range γ2 in the returning direction, but only the first asymptotic range γ1 may be set in the depressing direction.

As described, according to the first example shown in FIG. 5, the hysteresis includes the second deadband δ2 and the second asymptotic range γ2 in the returning direction. Specifically, as indicated in FIG. 5, the curve governed by the function F2(x) drawn within the second asymptotic range γ2 is bulged upwardly. That is, in the case of returning the accelerator pedal 2, a decreasing rate of the output value η with respect to a reduction in the input value θi of the accelerator pedal 2 within the second asymptotic range γ2 is increased with a reduction in depression of the accelerator pedal 2. In other words, an inclination of the curve governed by the function F2(x) within the second asymptotic range γ2 becomes steeper with a reduction in depression of the accelerator pedal 2. Accordingly, the output value η is not reduced sharply with respect to a reduction in the input value θi in an initial phase of returning the accelerator pedal 2, but a decreased amount of the output value η per unit operation of the accelerator pedal 2 is increased gradually with a reduction in depression of the accelerator pedal 2. According to the exemplary embodiment of the present disclosure, therefore, the drive force to propel the vehicle Ve can be reduced smoothly and continuously with respect to the reduction in depression of the accelerator pedal 2. In addition, even if a position of the accelerator pedal 2 is fixed while the accelerator pedal 2 is returned, the drive force to propel the vehicle Ve can be maintained stably.

After calculating the current output value ηi of the angle of the accelerator pedal 2 at step S8 or S9, the routine also progresses to step S6 to update the previous output value ηi−1 to the current output value ηi.

In addition, at step S6, the previous input value θi−1 is updated to the current input value θi, and thereafter the routine returns.

Thus, the control system according to the exemplary embodiment of the present disclosure is configured to control the prime mover 1 in response to an operation of the accelerator pedal 2. To this end, the accelerator sensor 3a collects an operating amount, an angle, a position and so on of the accelerator pedal 2, and transmits the collected information to the controller 4. The controller 4 calculates the output value η of the angle of the accelerator pedal 2 with respect to the input value θi transmitted from the accelerator sensor 3a based on the above-explained input-output characteristic, and transmits the calculated output value η to the prime mover 1 to control the drive force to propel the vehicle Ve based on the calculated output value η. As described, according to the exemplary embodiment of the present disclosure, the hysteresis is set between the input value θi and the output value η. According to the exemplary embodiment of the present disclosure, therefore, the prime mover 1 can be controlled without causing a hunting and a chattering.

As also described, according to the exemplary embodiment of the present disclosure, the hysteresis is set by combining the deadband δ with the asymptotic range γ. Since the hysteresis includes the deadband δ, an occurrence of the hunting or the chattering can be prevented. In addition, in the asymptotic range γ, the output value η of the angle of the accelerator pedal 2 is changed smoothly and continuously with respect to a change in the input value θi. According to the exemplary embodiment of the present disclosure, therefore, the output power of the prime mover 1 can be changed continuously and smoothly without causing a shock in response to a change in a position of the accelerator pedal 2. In addition, even if a position of the accelerator pedal 2 is fixed while the accelerator pedal 2 is depressed or returned, the drive force to propel the vehicle Ve can be maintained stably.

Although the above exemplary embodiments of the present disclosure have been described, it will be understood by those skilled in the art that the present disclosure should not be limited to the described exemplary embodiments, and various changes and modifications can be made within the scope of the present disclosure.

What is claimed is:

1. A control system for a vehicle having a prime mover, an accelerator pedal, and a detector that detects an operating amount of the accelerator pedal, comprising:
a controller that calculates an output value of the operating amount of the accelerator pedal with respect to an input value of the operating amount of the accelerator pedal transmitted from the detector with reference to a predetermined input-output characteristic including a hysteresis set between the input value and the output value, and that controls the prime mover based on the calculated output value,
wherein the hysteresis includes
a deadband in which the output value is not changed with respect to a change in the input value, or changed slightly with respect to a change in the input value but not sensed by a driver, and
an asymptotic range in which the output value is changed continuously with respect to a change in the input value based on a predetermined function indicated as a curve or a polygonal curve, when the input value is changed further than the deadband,
the controller is configured to
store the input-output characteristic, the deadband, and the asymptotic range,
increase the output value slightly with respect to an increase in the input value, or not to increase the output value with respect to an increase in the input value, when the input value is increased within the deadband,
reduce the output value slightly with respect to a reduction in the input value, or not to reduce the output value with respect to a reduction in the input value, when the input value is reduced within the deadband,
increase the output value with respect to an increase in the input value based on the function when the input value is increased further than the deadband, and
reduce the output value with respect to a reduction in the input value based on the function when the input value is reduced further than the deadband.

2. The control system for the vehicle as claimed in claim 1,
wherein the deadband includes at least any one of
a first deadband in which the output value is not increased or increased slightly with respect to an increase in the input value, and
a second deadband in which the output value is not reduced or reduced slightly with respect to a reduction in the input value, and
the asymptotic range includes at least any one of
a first asymptotic range in which the output value is increased with respect to an increase in the input value based on the function when the input value is increased further than the first deadband, and
a second asymptotic range in which the output value is reduced with respect to a reduction in the input value based on the function when the input value is reduced further than the second deadband.

3. The control system for the vehicle as claimed in claim 2, wherein the first asymptotic range is set in such a manner that an increasing rate of the output value with respect to an increase in the input value is increased with an increase in the operating amount of the accelerator pedal within the first asymptotic range.

4. The control system for the vehicle as claimed in claim 2, wherein the second asymptotic range is set in such a manner that a decreasing rate of the output value with respect to a reduction in the input value is increased with a reduction in the operating amount of the accelerator pedal within the second asymptotic range.
